(19) United States
(12) Patent Application Publication
(10) Pub. No.: US 2025/0366510 A1
(43) Pub. Date: Dec. 4, 2025

(54) SMOKING ARTICLE FOR PREVENTING NICOTINE TRANSFER AND AEROSOL GENERATING SYSTEM INCLUDING THE SAME

(71) Applicant: KT&G CORPORATION, Daejeon (KR)

(72) Inventors: Tae Kyung LEE, Daejeon (KR); Chan Min KWON, Daejeon (KR); Tae Kyun KIM, Daejeon (KR); Insu PARK, Daejeon (KR); Mi Jeong LEE, Daejeon (KR); John Tae LEE, Daejeon (KR)

(73) Assignee: KT&G CORPORATION, Daejeon (KR)

(21) Appl. No.: 18/568,504

(22) PCT Filed: Mar. 3, 2023
(86) PCT No.: PCT/KR2023/002910

§ 371 Date: Feb. 7, 2025

(30) Foreign Application Priority Data
Jun. 3, 2022 (KR) 10-2022-0068106

(51) Int. Cl. A24D 1/20; A24B 15/28; A24D 1/02; A24D 3/17; A24F 40/20; H05B 3/20

(52) U.S. Cl. CPC A24D 1/20; A24B 15/287; A24D 1/025; A24D 3/17; A24F 40/20; H05B 3/20

(57) ABSTRACT

The present disclosure relates to a smoking article for preventing a nicotine transfer phenomenon, and an aerosol generating system including the same. The smoking article includes a pH-adjusted medium portion; and a paper segment including an adsorption/release material. Since the pH-adjusted medium portion is included in the smoking article, nicotine may be transferred in a non-heating manner. Since the paper segment including the adsorption/release material is included in the smoking article, the nicotine transfer phenomenon may be prevented so that a coordinating period may be shortened, thereby securing stable shelf-life.

### TECHNICAL FIELD

The present disclosure relates to a smoking article for preventing a nicotine transfer phenomenon and an aerosol generating system including the smoking article.

### BACKGROUND ART

Recently, multiple smoking articles that are heated rather than combusted have been proposed. Unlike conventional smoking articles, such non-combustion smoking articles are used to inhale an aerosol generated by heating a tobacco medium instead of burning the tobacco medium. The types of such heated smoking articles include a smoking article using electrical heating.

Volatile free-base nicotine may be generated by adjusting pH of a medium portion of a smoking article and may be transferred in a non-heating manner.

In this regard, when a medium portion of a smoking product has acidic pH, it is difficult to transfer nicotine in the non-heating manner, and when the medium portion has alkaline pH, non-heating type nicotine transfer may be increased, but due to high volatility, nicotine may be transferred to packaging materials such as inner liners and pack wrapping paper in addition to a stick material product over time. Since nicotine transfer in smoke is greatly affected by nicotine transferred to a material product in the stick, nicotine transferred to packaging materials such as wrapping paper may reduce the amount of nicotine transfer in smoke.

That is, as a result, it was necessary to adjust the pH of the medium portion of the smoking product to be weakly alkaline, such as pH 8 to 9.5, which may give great smoking satisfaction, but a phenomenon in which nicotine is transferred to packaging materials, such as inner liners and pack wrapping paper, due to volatility occurs in the medium portion having alkaline pH.

Accordingly, a smoking article including a medium portion having weakly alkaline pH may transfer nicotine in the non-heating manner, but after manufacturing is completed, a coordinating period for transferring nicotine to a material product in a stick such as an acetate filter is essential, and a method of preventing a loss due to nicotine transfer to packaging materials to prevent a taste change after reaching nicotine transfer equilibrium in the stick is necessary.

### PRIOR ART DOCUMENT

### Patent Document

Korean Patent Publication No. 10-2021-0121968

### DISCLOSURE OF THE INVENTION

### Technical Goals

To solve the above-mentioned problems, the present disclosure provides a smoking article that includes a medium with adjusted pH and to which an adsorption/release material capable of preventing nicotine transfer is applied.

In addition, the present disclosure provides an aerosol generating system using a smoking article according to the present disclosure.

However, the technical goal obtainable from the present disclosure is not limited to those described above, and other goals not mentioned above can be clearly understood by one of ordinary skill in the art to which the present disclosure pertains from the following description.

### Technical Solutions

The present disclosure provides a smoking article for preventing a nicotine transfer phenomenon.

The smoking article includes a potential of hydrogen (pH)-adjusted medium portion; and a paper segment including an adsorption/release material.

In an implementation example of the present disclosure, the smoking article may further include a thermally conductive wrapper configured to surround at least one of the pH-adjusted medium portion and the paper segment.

In another implementation example of the present disclosure, the thermally conductive wrapper may be at least one selected from the group consisting of aluminum, gold, silver, and copper.

In another implementation example of the present disclosure, the pH-adjusted medium portion may have pH of 8 to 9.5.

In another implementation example of the present disclosure, the pH-adjusted medium portion may include volatile nicotine.

In another implementation example of the present disclosure, the paper segment may be disposed on one side or both sides of the medium portion.

In another implementation example of the present disclosure, the adsorption/release material may be at least one selected from the group consisting of activated carbon, zeolite, alumina, silica gel, and bentonite.

In another implementation example of the present disclosure, the smoking article may be a heated smoking article.

In another implementation example of the present disclosure, the smoking article may further include a tube filter portion and a filter portion.

In addition, the present disclosure provides an aerosol generating system including an aerosol generating device including a battery and a heater configured to generate heat by power supplied from the battery; and a smoking article according to the present disclosure accommodated in the aerosol generating device and configured to generate an aerosol by heating by the heater.

### Effects

When pH of a medium portion of a smoking article according to a related art is adjusted to improve the smoking satisfaction, free-base nicotine of the medium portion continues to be transferred in the smoking article, and accordingly a considerable coordinating period is required to achieve an equilibrium state with uniform quality. However, a smoking article of the present disclosure may further include a paper segment to which an adsorption/release material is applied, together with a pH-adjusted medium portion, to shorten a product coordinating period through rapid adsorption of volatile free-base nicotine within a short period of time, thereby securing stable shelf-life of a product. In addition, by preventing nicotine from being transferred to a part (e.g., a last outer cover, an inner liner, or pack wrapping paper) that does not have an influence on nicotine transfer in a smoking product, a loss of an amount of nicotine that may be transferred during smoking may be prevented, and stability of a filter may be maintained.

Furthermore, when the smoking article is used, nicotine adsorbed to the adsorption/release material may be desorbed and transferred by heating the paper segment to which the adsorption/release material is applied, and thus it is possible to prevent a loss of nicotine to other materials while transferring nicotine in a non-heating manner by including volatile nicotine, thereby obtaining high smoking satisfaction.

It should be understood that the effects of the present disclosure are not limited to the above-described effects, but are construed as including all effects that can be inferred from the configurations and features described in the following description or claims of the present disclosure.

### BRIEF DESCRIPTION OF DRAWINGS

FIG. 1 is a cross-sectional view of a smoking article according to an embodiment of the present disclosure.

FIG. 2 is a cross-sectional view of a smoking article according to another embodiment of the present disclosure.

FIG. 3 is a cross-sectional view of a smoking article according to another embodiment of the present disclosure.

FIG. 4A is a cross-sectional view of a smoking article according to another embodiment of the present disclosure.

FIG. 4B is a cross-sectional view of a smoking article according to another embodiment of the present disclosure.

FIG. 5 is a cross-sectional view of an aerosol generating system according to an embodiment of the present disclosure.

FIG. 6 is a cross-sectional view of an aerosol generating system according to another embodiment of the present disclosure.

### BEST MODE FOR CARRYING OUT THE INVENTION

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In the whole specification, when one member is positioned “on” another member, this not only includes a case that the one member is brought into contact with the other member, but also includes a case that another member exists between two members.

It will be understood that when a certain part “includes” a certain component, the part does not exclude another component but may further include another component.

According to an embodiment of the present disclosure, the “smoking article” may refer to any product that may be smoked or any product that may provide a smoking experience, regardless of whether the product is based on tobacco, tobacco derivatives, expanded tobacco, reconstituted tobacco, or tobacco substitutes.

In addition, throughout the specification, a “medium portion” refers to a portion or a part containing a smokeable material. In other words, the medium portion may indicate a portion including a material capable of transferring nicotine to a user.

Throughout the specification, a “paper segment” refers to a portion or a part including a paper material and a paper filter in contact with a medium portion.

Throughout the specification, potential of hydrogen may be an index indicating an amount of hydrogen ions present in a material and may be expressed as pH in the present specification.

Throughout the specification, the terms “upstream” and “downstream” are used, and when a user inhales the external air using a smoking article, a portion where the air flows to the inside from the outside of the smoking article is referred to as an “upstream” portion and a portion where the air flows out from the inside of the smoking article including a combustible heat source is referred to as a “downstream” portion. The terms “upstream” and “downstream” may be used to indicate a relative position or orientation between portions or segments constituting the smoking article.

Throughout the specification, an “adsorption/release material” refers to a material in which adsorption and release occur or may occur. In the present disclosure, the adsorption/release material generally refers to a material that is easily adsorbed and that allows an adsorbed material to be released by a physical treatment (e.g., heating).

Throughout the specification, an “aerosol generating device” may refer to a device that may generate an aerosol. The aerosol may include a volatile compound.

Hereinafter, a smoking article 1000 includes a pH-adjusted medium portion 200 of the present disclosure; and a paper segment 100 including an adsorption/release material 101.

The smoking article 1000 will be described in detail with reference to embodiments and drawings. However, the present disclosure is not limited to the embodiments and drawings.

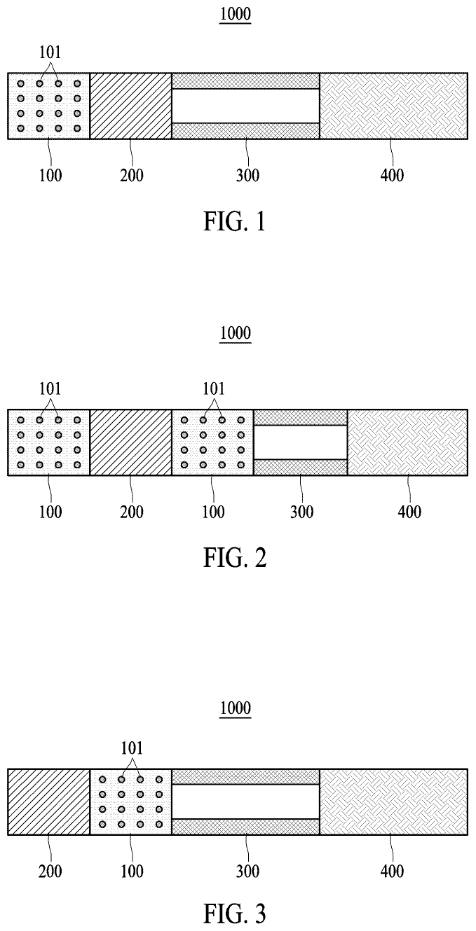

As shown in FIG. 1, the present disclosure corresponds to the smoking article 1000 including the pH-adjusted medium portion 200; and the paper segment 100 including the adsorption/release material 101.

According to an embodiment of the present disclosure, the paper segment may be disposed on one side or both sides of the medium portion. As shown in FIG. 1, the paper segment may be disposed on one side of the medium portion, that is, on an upstream side of the medium portion. Alternatively, as shown in FIG. 3, the paper segment may be disposed on a downstream side of the medium portion.

Alternatively, as shown in FIG. 2, paper segments may be disposed on both sides of the medium portion. As shown in FIG. 2, by applying a paper filter, to which an adsorption/release material is applied, to both sides of the medium portion, the adsorption/release material may adsorb free-base nicotine within a short period of time, thereby shortening a coordinating period, and nicotine may be prevented from being transferred to other materials (e.g., a last outer cover, an inner liner, pack wrapping paper, etc.) that do not have an influence on migration of nicotine, thereby preventing a nicotine loss and allowing other segments, such as a filter portion, a tube filter portion, and the like, included in the smoking article to stably function.

According to an embodiment of the present disclosure, the paper segment may include an adsorption/release material, and the adsorption/release material may be at least one selected from the group consisting of activated carbon, zeolite, alumina, silica gel, and bentonite. However, this is merely an example, and all materials capable of easily adsorb free-base nicotine and being released by treatment such as heating may be used.

The adsorption/release material may have an average particle diameter of 0.1 to 1000 micrometers (μm), and may desirably be a porous material such as activated carbon that includes pores to easily adsorb nicotine. The term “porous” refers to a state in which a solid has pores (gaps) inside or on a surface. The adsorption/release material may have a specific surface area of 300 m²/g or greater and a porosity of 10 to 80%. The porosity refers to a volume ratio between a substrate constituting a porous material and pores present in the substrate. If the porosity is less than 10%, nicotine may not be easily adsorbed due to insufficient porosity. If the porosity exceeds 80%, a possibility of prolonging the time for heating due to an excessive amount of nicotine to be adsorbed may be present.

The adsorption/release material may be included in an amount of 1 to 30% by weight (wt %) based on 100 wt % of the total weight of the paper segment. If the amount of the adsorption/release material is less than 1 wt %, nicotine may not be sufficiently adsorbed, and if the amount of the adsorption/release material exceeds 30 wt %, the adsorption/release material may not be sufficiently combined with the paper, and accordingly dust, and the like may be generated.

The adsorption/release material may be sprayed and included in base paper on which a crimp is formed. The adsorption/release material may utilize a binder to be easily combined with the base paper. The binder, which is a material having a viscosity of a predetermined level or greater, may include, but is not limited to, for example, a material such as glycerin, propylene glycol, guar gum, starch, ethylene-vinyl acetate, gum arabic, polyvinyl alcohol, or methyl cellulose.

An adsorptive material may be mixed with a binder in advance and the mixed material may be sprayed or applied to base paper, or the base paper may be coated with the mixed material. Alternatively, the base paper may be treated with the binder through spraying, applying or coating in advance, and the adsorptive material may be included in the base paper by spraying the adsorptive material onto the base paper treated with the binder. As described above, the base paper including the adsorptive material may be wound to have a predetermined thickness to manufacture a paper segment.

According to an embodiment, an amount of a binder applied to a surface of base paper may be 4 mg/mm or less, 3 mg/mm or less, 2 mg/mm or less, or 1 mg/mm or less, desirably in a range of 0.5 mg/mm to 4 mg/mm, 0.5 mg/mm to 3 mg/mm, or 0.5 mg/mm to 2 mg/mm.

The base paper may have a basis weight of 10 to 120 g/m². If the basis weight of the base paper is less than 10 g/m², hardness of the paper segment may decrease, which may have an influence on the quality of the entire smoking article, and if the basis weight of the base paper exceeds 120 g/m², it may be difficult to wind the base paper and manufacture the base paper in the form of a paper segment.

For example, the paper segment may have a diameter of 4 millimeters (mm) to 30 mm and a circumference of 14 mm to 29 mm. In addition, the paper segment may have a length of 10 mm to 70 mm, however, embodiments are not limited thereto.

According to an embodiment of the present disclosure, the smoking article of the present disclosure may include a pH-adjusted medium portion, and the pH-adjusted medium portion may have pH of 8 to 9.5. Since the pH-adjusted medium portion of the present disclosure has the pH of 8 to 9.5, nicotine included in the pH-adjusted medium portion may be in a free base state with volatility. Accordingly, when the smoking article of the present disclosure is used, nicotine may be smoothly transferred in a non-heating manner. However, in an example in which the pH-adjusted medium portion with the pH of 8 to 9.5 is included, when manufacturing is completed, nicotine may be transferred to a material product in a stick such as an acetate filter to have a uniform nicotine amount and a uniform quality, and a coordinating period to achieve a nicotine transfer equilibrium state may be essential. Therefore, by including an adsorption material in the paper segment on one side or both sides of a medium, the coordinating period for maintaining the uniform quality may be shortened, and after the coordinating period, a loss of nicotine caused by transferring nicotine to other materials (e.g., a last outer cover, an inner liner, pack wrapping paper, etc.) used to package a smoking article may be prevented.

According to an embodiment of the present disclosure, the pH-adjusted medium portion of the present disclosure may include volatile nicotine. The pH-adjusted medium portion of the present disclosure may include volatile nicotine, and accordingly, nicotine may be easily transferred in the non-heating manner during smoking. The volatile nicotine may not be included in the pH-adjusted medium portion only, and may be transferred from the pH-adjusted medium portion to paper segments and included in all of the paper segments.

The pH-adjusted medium portion may include an aerosol generating material, and may include, for example, a smoking material based on tobacco raw materials such as a paper-type reconstituted tobacco sheet, a slurry-type reconstituted tobacco sheet, granular tobacco, cut leaves, and the like. In addition, the pH-adjusted medium portion may have a structure in which the above-described smoking material is wrapped with cigarette paper, or may be a filter block including the smoking material. Alternatively, the smoking material may be included in a cavity portion by applying a cavity filter method.

In addition to the smoking material, a pH adjusting agent may be included to adjust the pH of the pH-adjusted medium portion of the present disclosure.

The pH adjusting agent may be at least one selected from the group consisting of carbonates including calcium carbonate, monocarbonate, bicarbonate and sesquicarbonate, acetates, glycinates, gluconates, borates, glycerophosphates or citrates of alkaline metals or ammonium, phosphate systems including monohydrogenphosphate, dihydrogenphosphate and trihydrogenphosphate, metal hydroxides such as sodium hydroxide and potassium hydroxide, and mixtures thereof.

The pH-adjusted medium portion of the present disclosure may include a binder in addition to the smoking material, to have a granular form. The binder may use a component such as pullulan, dextrin, cellulose, or glycerin, however, embodiments are not limited thereto.

According to an embodiment of the present disclosure, the smoking article according to the present disclosure may be a heated smoking article. The heated smoking article refers to an article in which smoking is performed by applying heat by a heating device such as a heater without burning.

According to an embodiment of the present disclosure, the smoking article may further include a thermally conductive wrapper configured to surround at least one of the pH-adjusted medium portion and the paper segment. By including the thermally conductive wrapper, nicotine adsorbed to the adsorption/release material may be more effectively released. In general, when the thermally conductive wrapper is not included, smoking may be performed by heating at a temperature around 200° C., and when the thermally conductive wrapper is included, smoking may be performed even at a temperature of less than 200° C.

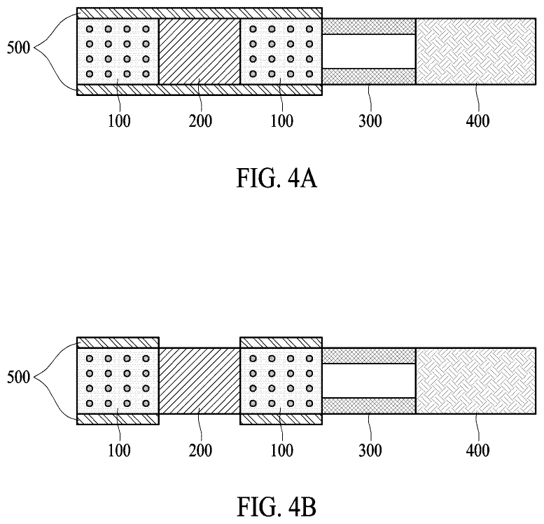

As an example of an arrangement of the thermally conductive wrapper in the smoking article, the thermally conductive wrapper may surround both the pH-adjusted medium portion and the paper segment as shown in FIG. 4A. Alternatively, as shown in FIG. 4B, the thermally conductive wrapper may surround the paper segment only.

The thermally conductive wrapper may be paper, flax, wood pulp, or polymeric material including a thermally conductive material. The thermally conductive material may be at least one selected from the group consisting of aluminum, gold, silver, copper, or carbon nanotubes, and may include, but is not limited to, all materials capable of transferring heat generated from a heater to a paper segment or a medium portion. Desirably, the thermally conductive wrapper of the present disclosure may be in the form of paper and aluminum foil laminated.

The thermally conductive wrapper may have a thickness of about 30 μm to about 300 μm. When the thickness of the thermally conductive wrapper is less than 30 μm, the effect on heat transfer may be reduced, and when the thickness of the thermally conductive wrapper exceeds 300 μm, an airflow may be affected.

According to an embodiment of the present disclosure, the smoking article may further include a tube filter portion and a filter portion.

According to an embodiment of the present disclosure, the smoking article may further include a tube filter portion in addition to the medium portion and the paper segment. The tube filter portion may gather an aerosol generated from a tobacco material into a central portion of a stick and may support the tobacco material to prevent the tobacco material from being pushed downstream. The tube filter portion may be formed of a paper material, a polymer material, and the like, and may include, for example, all materials used in heated tobacco without being limited to the above-described material.

According to an embodiment of the present disclosure, the smoking article may include a filter portion. For example, the filter portion may be a mono filter, a dual filter, or a triple filter. In addition, the filter portion may include a filter with at least one of a porous matrix structure, a tube structure, and a paper tube structure. The filter may include a filter tow in a fibrous form, a filamentous form, or both. The fibrous form and the filamentous form may each include at least one of a polymer, paper, cellulose acetate, activated carbon, and carbon. However, embodiments are not limited thereto. In some embodiments, a filter material may further include at least one filter material widely known in the technical field, such as a carbon-containing adsorbent or activated carbon.

For example, the smoking article may have a diameter of 4 mm to 10 mm and a perimeter of 14 mm to 29 mm. In addition, the smoking article may have a length of 45 mm to 100 mm, however, embodiments are not limited thereto.

In addition, the present disclosure provides an aerosol generating system 3000 that includes an aerosol generating device 2000 including a battery 500, a heater 600 configured to generate heat by power supplied from the battery 500, and a vaporizer 1100; and the above-described smoking article 1000 accommodated in the aerosol generating device 2000 and configured to generate an aerosol by heating by the heater 600.

The term “aerosol generating device” used herein may refer to a device that generates an aerosol using a tobacco medium such that the aerosol may be inhaled through a mouth of a user directly to a lung of the user.

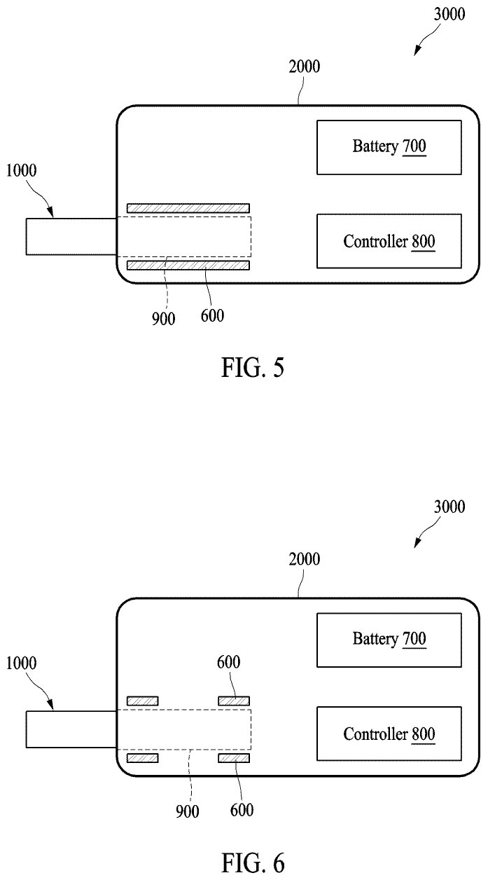

As an example, the aerosol generating device is shown in FIG. 5. However, FIG. 5 illustrates only components related to the embodiment of the present disclosure, and one of ordinary skill in the art to which the present disclosure belongs can understand that general-purpose components other than the components shown in FIG. 5 may be further included. Hereinafter, components of the aerosol generating device 2000 are described.

The aerosol generating device may further include a controller 800, and an accommodation space 900, in addition to the heater 600, a battery 700, and the vaporizer 1100 in which the smoking article is accommodated. However, this is merely a desirable example to achieve the aspect of the present disclosure, and thus other components may be added or some of the components may be omitted as needed.

Each of the components of the aerosol generating device shown in FIG. 5 shows functional elements which are functionally distinguished, and a plurality of elements may be implemented in an integrated form in an actual physical environment, or a single component may be implemented in the form of being separated into a plurality of detailed functional elements.

Referring to FIG. 5, the smoking article 1000 may include the heater 600, an aerosol may be generated by heat generated from the heater, and the generated aerosol may be inhaled through the mouth of the user in contact with a filter portion through the smoking article 1000.

The heater 600 may generate the aerosol by heating the smoking article accommodated in the accommodation space 900. In other words, the heater 600 may be disposed to surround the accommodation space to heat the smoking article 1000 accommodated in the accommodation space. The heater may be implemented as an electrically resistive heater.

The heater may be, for example, a single heater or a multi-stage heater. As shown in FIG. 5, a single heater may be used to heat a paper segment and a medium portion at the same time.

Alternatively, in another embodiment, as shown in FIG. 6, a multi-stage heater may be provided so that the heater may heat only the paper segment. In general, since if adsorption energy is large, desorption energy may also be large, free-base nicotine adsorbed to a material may be desorbed through minimum heating of a part, to which the adsorption/release material is applied, and may be transferred. Thus, nicotine may be transferred only during use without a loss of free-base nicotine.

However, the scope of the disclosure is not limited to these examples. The smoking article of the present disclosure may include a thermally conductive wrapper, and the paper segment and the pH-adjusted medium portion may be arranged in various forms, as described above, and thus the arrangement of the heater may change according to the design and configuration of the smoking article.

The vaporizer 1100 may include a liquid composition; a liquid storage containing the liquid composition; and an atomization element configured to atomize the liquid composition. Although not shown in the drawings, a passage through which an aerosol generated by the atomization element may be transferred may be included in a gap of the accommodation space in which the smoking article is accommodated in the vaporizer.

The atomization element may be a heater for heating the liquid composition or a vibrator for supplying vibrational energy to the liquid composition. An aerosol may be generated by applying heat or vibration to the liquid composition. The liquid composition may include at least one of propylene glycol (PG) and glycerin (GLY), and may further include at least one of ethylene glycol, dipropylene glycol, diethylene glycol, triethylene glycol, tetraethylene glycol, and oleyl alcohol.

The controller 800 may control the overall operation of the aerosol generating device 2000. For example, the controller 800 may control operations of the heater 600 and the battery 700 and also control operations of other components included in the aerosol generating device 2000. The controller 800 may control power supplied by the battery 700, a heating temperature of the heater 600, and the like. The battery may be a rechargeable battery or a non-rechargeable battery. Suitable batteries may include, for example, a lithium-ion battery, a nickel battery (e.g., a nickel-cadmium battery), an alkaline battery, and the like.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

### EXPLANATION OF REFERENCE NUMERALS

| | |
|---|---|
| 100: Paper segment | 200: pH-adjusted medium portion |
| 300: Tube filter portion | 400: Filter portion |
| 500: Thermally conductive wrapper | 600: Heater |
| 700: Battery | 800: Controller |
| 900: Accommodation space | 1000: Smoking article |
| 2000: Aerosol generating device | 3000: Aerosol generating system |

### Industrial Availability

The smoking article of the present disclosure may further include a paper segment, to which an adsorption/release material is applied, together with a pH-adjusted medium portion, to shorten a product coordinating period through rapid adsorption of volatile free-base nicotine within a short period of time, thereby securing stable shelf-life of a product. In addition, by preventing nicotine from being transferred to other parts, a loss of an amount of nicotine may be prevented. During use of the smoking article, it may be possible to transfer adsorbed volatile nicotine by heating the paper segment, thereby obtaining high smoking satisfaction. Therefore, the smoking article may be usefully used in the smoking product industry field.

1. A smoking article for preventing a nicotine transfer phenomenon, the smoking article comprising:
a pH-adjusted medium portion; and
a paper segment comprising an adsorption/release material.

2. The smoking article of claim 1, further comprising:
a thermally conductive wrapper configured to surround at least one of the pH-adjusted medium portion and the paper segment.

3. The smoking article of claim 2, wherein the thermally conductive wrapper is at least one selected from the group consisting of aluminum, gold, silver, and copper.

4. The smoking article of claim 1, wherein the pH-adjusted medium portion has a pH of 8 to 9.5.

5. The smoking article of claim 4, wherein the pH-adjusted medium portion comprises volatile nicotine.

6. The smoking article of claim 1, wherein the paper segment is disposed on one side or both sides of the pH-adjusted medium portion.

7. The smoking article of claim 1, wherein the adsorption/release material is at least one selected from the group consisting of activated carbon, zeolite, alumina, silica gel, and bentonite.

8. The smoking article of claim 1, wherein the smoking article is a heated smoking article.

9. The smoking article of claim 1, further comprising:
a tube filter portion and a filter portion.

10. An aerosol generating system comprising:
an aerosol generating device comprising a battery and a heater configured to generate heat by power supplied from the battery; and
the smoking article of claim 1 accommodated in the aerosol generating device and configured to generate an aerosol by heating by the heater.
